(19) United States
(12) Patent Application Publication
(10) Pub. No.: US 2010/0057422 A1
(43) Pub. Date: Mar. 4, 2010

(54) COMMUNICATION QUALITY EVALUATION METHOD, COMMUNICATION QUALITY EVALUATION DEVICE AND COMMUNICATION QUALITY EVALUATION PROGRAM FOR WIRELESS LAN SYSTEM

(75) Inventors: Koichi Ebata, Tokyo (JP); Wataru Domon, Tokyo (JP)

Correspondence Address: YOUNG & THOMPSON, 209 Madison Street, Suite 500, Alexandria, VA, 22314, US

(73) Assignee: NEC Corporation, Tokyo (JP)

(21) Appl. No.: 12/444,538

(22) PCT Filed: Oct. 5, 2007
(86) PCT No.: PCT/JP2007/070027

§ 371 Date: Apr. 6, 2009

(30) Foreign Application Priority Data
Oct. 6, 2006 (JP) 2006-274907

(51) Int. Cl. G06F 17/50; H04L 12/26

(52) U.S. Cl. 703/13; 370/241

(57) ABSTRACT

The object is to reduce the amount of processing in network simulation executed at the time of evaluating communication quality of a wireless LAN and reduce computation time of simulation based on a set radio wave propagation situation. At a step of executing network simulation in a wireless LAN communication quality evaluation method using network simulation, a situation of arrival of a radio wave transmitted by a terminal at other access point or other terminal is considered to be the same as a situation of arrival of a radio wave transmitted by an access point to which the terminal belongs at other access point or an access point to which other terminal belongs.

### TECHNICAL FIELD

The present invention relates to a communication quality evaluation method, a communication quality evaluation device and a communication quality evaluation program for a wireless LAN system and, more particularly, a communication quality evaluation method, a communication quality evaluation device and a communication quality evaluation program for a wireless LAN system which use network simulation.

### BACKGROUND ART

Methods of evaluating communication quality on a communication network are classified roughly into two, a method of measuring and evaluating quality by using a real machine and a method of, with a virtual model logically formed on a computer, calculating and evaluating quality by simulation. Since the evaluation method using a real machine obtains a result closer to an actual operation situation, it is more appropriate. When a network to be evaluated is large in size or has a complicated structure, however, setting up its environment in practice requires time and costs. The evaluation method using simulation is therefore more practical.

For evaluating network communication quality, network simulators are used (see Literature 1 and Literature 2). When evaluating communication quality of a wireless LAN by using these simulators, such a procedure as shown in FIG. 8 is executed, for example.

FIG. 8 is a flow chart simply showing operation of a common network simulator. The network simulator first sets a condition in which simulation is executed (Step S810). More specifically, the network simulator executes processing of setting topology (Step S811), processing of setting a radio wave propagation situation (Step S812) and processing of setting other simulation conditions (Step S813). The network simulator defines topology of a network to be simulated at Step S811.

FIG. 9 is a diagram of a network structure showing one example of topology defined by the network simulator. In the structure shown in FIG. 9, the network topology includes a wired network 910, a switch 920, an access point (hereinafter referred to as AP) 930 and a terminal 940.

The network simulator sets a radio wave propagation situation (Step S812). The radio wave propagation situation indicates a relationship of radio wave receivability between all the radio nodes including an AP and a terminal. Radio wave propagation situation is used for determining whether at a time of simulation of a wireless LAN, a packet transmitted from a certain radio node collides with a packet transmitted by other radio node on a radio medium to fail in reception or whether existence of a packet on a radio medium causes transmission to be postponed. Radio wave propagation situation is also used for determining an AP to which each terminal belongs. It is therefore necessary to seize and set a radio wave propagation situation between all the radio nodes including an AP and a terminal.

While propagation characteristics are obtained by actual measurement or simulation, an increase in the number of radio nodes to be set leads to an increase in the volume of work in a case of actual measurement and in the amount of computation in a case of simulation. A network simulator may sometimes set a radio wave propagation situation by using such a manner of inputting a physical positional relationship at Step S811 and calculating a distance attenuation from the positional relationship. When involving moving of a terminal, it is necessary to set a radio propagation situation between all the other radio nodes and each place to which the terminal moves. When a terminal moves, a larger volume of work and amount of computation are therefore required.

The network simulator sets other simulation conditions at Step S813. Among conditions to be set are a traffic load, traffic characteristics and transmission path error characteristics.

Traffic load is equivalent to setting traffic caused by each terminal. Assuming voice communication, for example, it is equivalent to the number of calls.

On the other hand, traffic characteristics depend on a kind of traffic to be evaluated, for example, voice communication, Web browsing, file transfer or data base access.

Transmission path error characteristics are characteristics to be set because of a transmission error existing on a radio transmission path.

After setting each condition as described above, the network simulator executes network simulation (Step S814). At Step S814, simulate behavior from occurrence of traffic at each terminal until its arrival at a destination node. More specifically, simulated is behavior until reaching a destination node while selecting an appropriate path after traffic occurs at each terminal and the traffic is formed as a packet and received at AP through a radio medium.

The network simulator simulates at Step S814 behavior of packet transmission and reception at all the nodes. When a network to be evaluated is large in scale, therefore, there occurs a case where the amount of computation becomes enormous. Packet transmission and reception at a radio node, in particular, unlike a wired node connected only to a small number of specific nodes, requires determination of standby or collision based on packets sent from all the radio nodes. As a result, the amount of computation becomes extremely great (large).

In the course of the simulation at Step S814, a delay time, an abandonment situation due to collision in a radio medium and the like in each processing of each packet are recorded. Executed at Step S815 is processing of summing up these information recorded during the simulation after the simulation ends and considering the summed up information as an evaluation result. Then, express the evaluation result obtained by summing by the processing at Step S815 on an external file or a display in a form understandable for a user (Step S816). This enables the user to confirm the evaluation result to evaluate communication quality on a wireless LAN to be evaluated.

As described in the foregoing, at the time of setting a radio wave propagation situation (the above-described Step S812), a common network simulator requires setting of a radio wave propagation situation of all the radio nodes including an AP and a terminal. It is therefore necessary to seize a radio wave propagation situation between all the radio nodes prior to setting. Used as a means for seizing a radio wave propagation situation is a method of measuring reception power by using a real machine, a method of executing calculation based on a statistical model of radio wave propagation or a method of executing radio wave propagation simulation.

Literature 1: Japanese Patent Laying-Open No. H11-007421 (paragraphs 0051-0065, FIG. 1, FIG. 4, FIG. 5)

Literature 2: “*Network Simulation Software OPNET Modeler Modeling Method” [on line], Joho Kobo Inc., [searched on September 29, H18], Internet <URL: http://www.johokobo.co.jp/opnet/modeler/opnet modeler a.h tml>

The evaluation using a real machine, however, has a problem that a large volume of work is required for setting up environment or measurement. Furthermore, it cannot be appropriate as a means for use in quality evaluation at the stage of station designing.

Computation and radio wave propagation simulation based on a statistical model also have a problem that the larger the number of radio nodes as a target becomes, the larger the amount of computation becomes to require enormous time for deriving. This is because a radio propagation situation to be seized will be equivalent to the number of all the combinations among radio nodes to be evaluated.

Moreover, when a terminal moves, a radio wave propagation situation should be seized for each a movement destination of a moving terminal, which requires more time.

Another problem of a common network simulator is that when making determination on standby or collision of a transmission packet of a certain node at the execution of simulation, the determination should be made based on a transmission situation and a radio wave propagation situation of all the radio nodes. As a result, the amount of processing is increased to require enormous computation time for obtaining an evaluation result.

### OBJECT

Thus, an object of the present invention is to provide a communication quality evaluation method, a communication quality evaluation device and a communication quality evaluation program for a wireless LAN system that enable radio wave propagation situation seizing processing, which will require a large amount of computation, to be reduced and enable evaluation in a short time period when evaluating communication quality of wireless LAN system using network simulation.

Another object of the present invention is to provide a communication quality evaluation method, a communication quality evaluation device and a communication quality evaluation program for a wireless LAN system that enable the amount of determination processing related to transmission packet standby or collision in simulation, which will require a large amount of computation, to be reduced and enable evaluation in a short time period when evaluating communication quality of wireless LAN system using network simulation.

### SUMMARY

According to a first exemplary aspect of the invention, a communication quality evaluation method of a wireless LAN system using network simulation, wherein in network simulation,

considering a situation of arrival of a radio wave transmitted by a terminal at other access point or other terminal to be the same as a situation of arrival of a radio wave transmitted by an access point to which the terminal belongs at other access point or an access point to which other terminal belongs.

According to a second exemplary aspect of the invention, a communication quality evaluation device of a wireless LAN system which executes network simulation, includes a network simulation unit which executes the network simulation, wherein the network simulation unit, at the time of executing network simulation, considers a situation of arrival of a radio wave transmitted by a terminal at other access point or other terminal to be the same as a situation of arrival of a radio wave transmitted by an access point to which the terminal belongs at other access point or an access point to which other terminal belongs.

According to a third exemplary aspect of the invention, a communication quality evaluation program which causes a computer to execute, in simulation executing processing, processing of considering a situation of arrival of a radio wave transmitted by a terminal at other access point or other terminal to be the same as a situation of arrival of a radio wave transmitted by an access point to which the terminal belongs at other access point or an access point to which other terminal belongs.

### EFFECT

The present invention enables time required for obtaining a communication quality evaluation result to be reduced in evaluation of communication quality of a wireless LAN system.

### BRIEF DESCRIPTION OF THE DRAWINGS

FIG. 1 is a block diagram showing one example of a structure of a communication quality evaluation device according to a first exemplary embodiment of the present invention;

FIG. 2 is a flow chart showing operation of the communication quality evaluation device according to the first exemplary embodiment;

FIG. 3 is a diagram for use in explaining one example of a radio wave propagation situation;

FIG. 4 is a diagram showing one example of an assignment relationship between an AP and a terminal;

FIG. 5 is a diagram for use in explaining one example of handling of a radio node according to a second exemplary embodiment;

FIG. 6 is a system diagram showing one example of a structure when making use of a communication quality evaluation device as ASP service;

FIG. 7 is a flow chart showing a procedure of quality evaluation illustrated in FIG. 6;

FIG. 8 is a flow chart showing, in simplification, operation of a common network simulator; and

FIG. 9 is a diagram showing a network structure of one example of topology defined by a network simulator.

### EXEMPLARY EMBODIMENT

### First Exemplary Embodiment

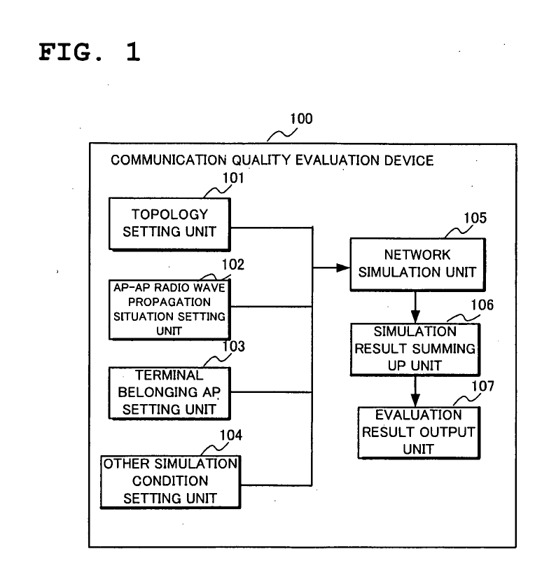

In the following, a first exemplary embodiment of the present invention will be described reference to the drawings. FIG. 1 is a block diagram showing one example of a structure of a communication quality evaluation device according to the first exemplary embodiment of the present invention. As illustrated in FIG. 1, a communication quality evaluation device 100 according to the first exemplary embodiment includes a topology setting unit 101, an AP-AP radio wave propagation situation setting unit 102, a terminal belonging AP setting unit 103, other simulation condition setting unit 104, a network simulation unit 105, a simulation result summing up unit 106 and an evaluation result output unit 107. The communication quality evaluation device 100 can be realized by, for example, a computer which executes processing according to a program.

The topology setting unit 101 has a function of setting topology of a network to be simulated to provide the network simulation unit 105 with the same as a simulation condition. The topology setting unit 101 sets, for example, only the number of APs as a simple setting example.

The AP-AP radio wave propagation situation setting unit 102 has a function of setting a radio wave propagation situation indicating whether radio waves transmitted by a certain AP reach other AP to provide the network simulation unit 105 with the situation as a simulation condition. The network simulation unit 105 makes determination on standby or collision in packet transmission based on information provided from the AP-AP radio wave propagation situation setting unit 102.

The terminal belonging AP setting unit 103 sets to which access point each terminal included in the topology which is set by the topology setting unit 101 belongs. Then, the terminal belonging AP setting unit 103 has a function of providing the network simulation unit 105 with the set contents as a simulation condition. The terminal belonging AP setting unit 103 may be allowed to set only the number of terminals belonging to each AP.

The other simulation condition setting unit 104 has a function of setting such conditions necessary for network simulation as the volume of traffic, traffic characteristics, and transmission path error characteristics and providing the network simulation unit 105 with the condition.

The network simulation unit 105 simulates from transmission to reception of a packet of traffic generated at each node based on a simulation condition provided from each setting unit and records information related to a delay or a loss.

In simulation by the network simulation unit 105, behavior in radio wave propagation is simulated. More specifically, the network simulation unit 105 makes determination on standby or collision of packets based on a radio wave propagation situation and information of an AP to which each terminal belongs which are set by the AP-AP radio wave propagation situation setting unit 102 and the terminal belonging AP setting unit 103 to simulate behavior in radio wave propagation.

When simulation by the network simulation unit 105 ends, the simulation result summing up unit 106 sums up simulation results. More specifically, with respect to a delay or a loss rate of a packet at each node recorded during the simulation, the simulation result summing up unit 106 derives an average value, a maximum value, a minimum value and the like for the entire system or on a channel basis according to the contents of evaluation and takes it as an evaluation result.

The evaluation result derived by summing up the simulation results by the simulation result summing up unit 106 is output to the evaluation result output unit 107. Among an evaluation result output methods are outputting to an external file or displaying on a display.

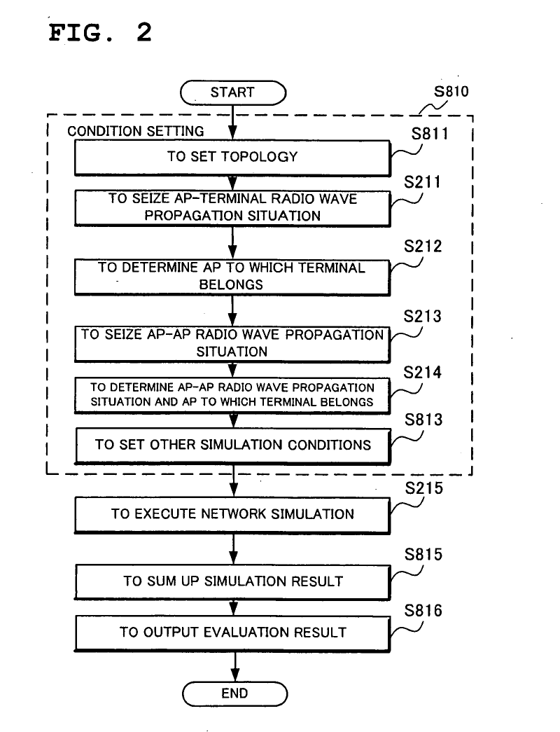

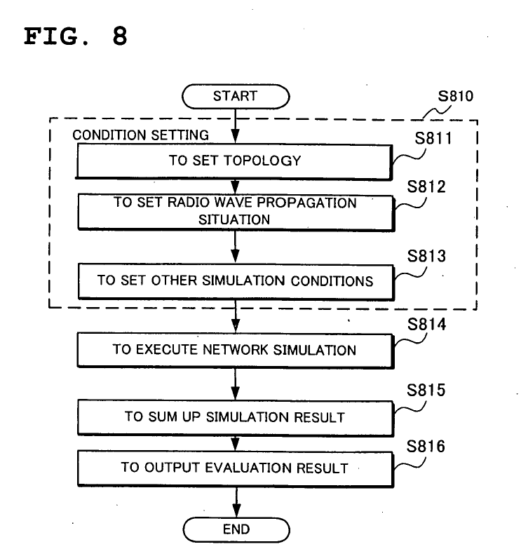

Next, operation of the communication quality evaluation device 100 will be described with reference to the drawings. FIG. 2 is a flow chart showing operation of the communication quality evaluation device 100. In FIG. 2, the same processing as the processing executed by a common network simulator shown in FIG. 8 is given the same reference numeral as the reference numeral in FIG. 8.

When evaluating communication quality of a wireless LAN system, the communication quality evaluation device 100 first sets a condition for simulation (Step S810). More specifically, the communication quality evaluation device 100 executes processing of setting topology (Step S811), processing of seizing a radio wave propagation situation between an AP and a terminal (Step S211), processing of determining an AP to which a terminal belongs (Step S212), processing of seizing a radio wave propagation situation between APs (Step S213), processing of setting a radio wave propagation situation between APs and an AP to which a terminal belongs (Step S214) and processing of setting other simulation conditions (Step S813).

In this communication quality evaluation method according to the present exemplary embodiment, the processing for setting conditions differs from the processing shown in FIG. 8. More specifically, the processing at Step S812 shown in FIG. 8 is replaced by the processing at Steps S212 through S214.

The network simulator which executes the processing shown in FIG. 8 needs to seize and set radio wave propagation situations related to all the radio nodes including an AP and a terminal at Step S812. The communication quality evaluation device 100 according to the first exemplary embodiment, however, seizes a radio wave propagation situation between an AP and a terminal and between APs (Step S211 through S214) and sets only an AP to which a terminal belongs and a radio base propagation situation between APs. Therefore, it will be unnecessary to seize a radio wave propagation situation between terminals, thereby enabling reduction in the amount of computation.

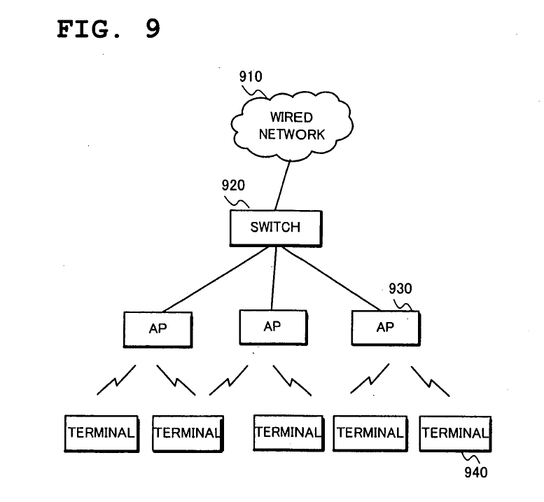

As condition setting, the communication quality evaluation device 100 first sets topology of a network to be simulated (Step S811). More specifically, the topology setting unit 101 sets topology. The processing at Step S811 is equivalent to processing executed by a common network simulator. The topology setting unit 101 sets, for example, such topology as shown in FIG. 9.

When evaluating only a wireless LAN part, there is a case where only the number of APs and the number of terminals are set and no setting is made with respect to a switch and a wired network. As to a terminal, because a relationship of assignment to each AP is set at Step S214 which will be described later, only the number of APs may be set at Step S811.

Next, the AP-AP radio wave propagation situation setting unit 102 seizes a situation of radio wave propagation between an AP and a terminal (Step S211). The processing at Step S211 is processing of seizing a situation of radio wave propagation between an AP and a terminal in order to determine an AP to which a terminal belongs by the processing at the subsequent Step S212. A radio wave propagation situation to be seized indicates whether radio waves transmitted by a certain AP reach other AP or not.

While used as a radio wave propagation situation are, for example, reception power, delay spread, SNR (signal to noise ratio) and SIR (signal to interference ratio), it is a common practice to use reception power.

Among methods of seizing a radio wave propagation situation are a method of actually setting up a system to be evaluated by using a real machine and measuring the same, a calculating method using a statistical model of radio wave propagation characteristics and a method of simulating and deriving radio wave propagation by using the ray tracing method or the like.

Next, the terminal belonging AP setting unit 103 determines an AP to which each terminal belongs based on the radio wave propagation situation seized at Step S211 (Step S212). As a specific method of determining an AP to which a terminal belongs, possible (used) is a method of selecting an AP whose reception power will be the largest among APs whose reception power is not less a specific reception power (e.g. −80 dBm). In the present exemplary embodiment, a method of determining an assigned AP is not limited in particular.

When an AP to which each terminal belongs is determined at Step S212, seizing the number of terminals belonging to each AP is enabled. As long as an AP to which a terminal belongs can be seized at Step S212, the processing at Step S211 can be executed by any manner. The method of seizing a radio wave propagation situation used at Step S211 may be based, for example, on a distance between an AP and a terminal to determine an AP whose distance to each terminal is the shortest as an assigned AP. When executing simulation with an assignment relationship of a terminal to an AP determined in advance, Step S211 may be omitted. In this case, an AP to which a terminal belongs is determined by the processing at Step S212. Further by the processing at Step S212, only the number of terminals belonging to each AP may be determined.

Next, the AP-AP radio wave propagation situation setting unit 102 seizes a radio wave propagation situation between APs (Step S213). Radio wave propagation situation indicates whether radio waves transmitted by a certain AP reach other AP or not. While used as a radio wave propagation situation to be seized are, for example, reception power, delay spread, SNR (signal to noise ration) and SIR (signal to interference ratio) similarly to the above-described case of that between an AP and a terminal, it is a common practice to use reception power. Among methods of seizing a radio wave propagation situation are a method of actually setting up a system to be evaluated by using a real machine and measuring the same, a calculating method using a statistical model of radio wave propagation characteristics and a method of simulating and deriving radio wave propagation by using the ray tracing method or the like.

After seizing an AP-AP radio wave propagation situation by the processing at Step S213, the AP-AP radio wave propagation situation setting unit 102 and the terminal belonging AP setting unit 103 set the seized radio wave propagation situation and information of an AP to which each terminal belongs that is determined by the processing at Step S212 as simulation conditions (Step S214). The AP-AP radio wave propagation situation setting at Step S214 is executed by the AP-AP radio wave propagation situation setting unit 102. Setting of an AP to which each terminal belongs is executed by the terminal belonging AP setting unit 103.

AP-AP radio wave propagation situation required in simulation is not information such as a detailed reception power value but information for determining whether a packet transmitted by a certain AP can be received at other AP or it collides with a packet transmitted by other AP. Accordingly, the simplest form of an AP-AP radio wave propagation situation set at Step S214 is to indicate whether radio waves transmitted from a certain AP can be received at a certain AP.

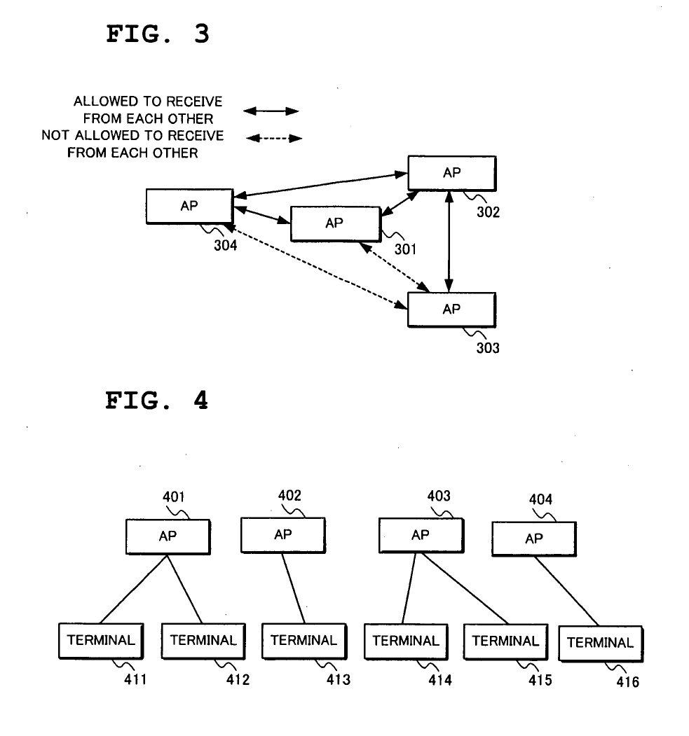

The AP-AP radio wave propagation situation can be expressed by using a matrix. Expression (1) set forth below is an example of representation, in a form of a matrix, of a result of a receivability relationship obtained based on an AP-AP radio wave propagation situation in such a case of topology as shown in FIG. 3.

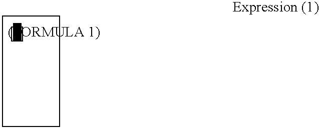

The example shown in FIG. 3 is premised on that there exist four APs. Then, illustrated in FIG. 3 is a situation where an AP 301 is allowed to receive from an AP 302 and an AP304 and vice versa but not from an AP303 and vice versa, that the AP302 is allowed to receive from all the APs and vice versa, that the AP 303 is allowed to receive only from the AP 302 and vice versa and that the AP 304 is allowed to receive from the AP 301 and the AP 302 and vice versa but not from the AP 303 and vice versa.

In the matrix represented by the expression (1), each row is regarded to represent a reception AP and each column is regarded to represent a transmission AP. In the matrix represented by the expression (1), for example, each row represents a situation of the reception AP, in which situations of AP1, AP2, AP3 and AP4 are represented starting with the first row. Also in the matrix represented by the expression (1), each column represents a situation of the transmission AP, in which situations of the AP1, the AP2, the AP3 and the AP4 are represented starting from left (first column).

As the values of the matrix, “1” is represented when an AP expressed in the column executes transmission, if an AP expressed in the row is allowed to receive it, and “0” is represented if not allowed to receive it. In a case, for example, where the reception AP is the AP1 and the transmission AP is the AP3, “0” representing that they are not allowed to receive from each other is recited in the first row, the third column in the matrix. When the transmission and the reception APs are the same AP (first row, first column, second row, the second column, . . . n-row, n-column), “1” is represented.

While in the present exemplary embodiment, the row of the matrix represents a reception AP and the column represents a transmission AP, the reverse is possible (i.e. the row of the matrix represents a transmission AP and the column represents a reception AP). As described above, as compared with an ordinary method in which a value of reception power is recited as it is, reciting an AP-AP receivability relationship as a matrix enables the number of other APs which are allowed to receive from a certain AP to be seized with ease. Another advantage is easiness to handle for a user of simulation who executes setting.

In the setting of a terminal belonging AP (Step S214), only the information about how many terminals each AP has assigned may be set without setting an assignment relationship between each terminal and an AP one by one. In this case, processing related to a terminal (Step S811 and Step S211) will be omitted to determine how many terminals belong to each AP (Step S212). Then, based on the determination, set only the number of terminals belonging to each AP (Step S214).

On the other hand, when executing simulation taking terminal movement into consideration, seize a situation of radio wave propagation between an AP and a terminal at each time point (Step S211) to set information about an AP to which each terminal belongs at each time point seized (Step S214). Then, by changing an AP to which each terminal belongs at each time point when executing the simulation at Step S215 which will be described later, simulate behavior of a moving terminal.

Next, the other simulation condition setting unit 104 sets other simulation conditions (Step S813). At Step S813, similarly to the case of the method shown in FIG. 8, set a traffic load, traffic characteristics, transmission path error characteristic and the like.

Traffic load is equivalent to setting traffic generated by each terminal. Assuming voice communication, for example, a traffic load is equivalent to the number of calls. In quality evaluation of a wireless LAN, a traffic load generated per one cell formed by one AP and a terminal belonging to the AP becomes a crucial index at the time of evaluating the amount of accommodations. Then, a traffic load per cell depends in general on the number of terminals in the cell.

Setting in a manner as described above requires each terminal to be set to generate the same traffic load. In this case, a traffic load of each cell will be a value dependent on the number of terminals in the cell.

The traffic characteristics depend on a kind of traffic to be evaluated, for example, voice communication, Web browsing, file transfer or data base access. As to transmission path error characteristic, because there exists a transmission error on a radio transmission path, such a characteristic is set as a transmission path error characteristic.

As described in the foregoing, the processing at Step S810 is the processing for setting various kinds of conditions for executing simulation. While in the flow chart shown in FIG. 2, illustrated is sequential execution of each step, as to items having no dependency on each other (e.g. the processing at Step S813 and processing at other steps), execution order is not limited in particular.

When the condition setting is completed, the network simulation unit 105 executes network simulation according to the set condition (Step S215).

As compared with common network simulation (e.g. the processing at Step S814 in FIG. 8), the processing at Step S215 differs in handling a wireless radio wave propagation situation, that is, information indicating whether a radio wave of a certain radio node reaches other radio node or not. In common network simulation, because radio wave propagation situations related to all the APs and all the terminals are set, whether a packet transmitted by a certain radio node can be received by other radio node or not depends on a radio wave propagation situation of each individual radio node.

On the other hand, in the network simulation according to the present exemplary embodiment, only an AP-AP radio wave propagation situation and a terminal belonging AP are set (Step S214). As to a radio wave propagation situation of a terminal, therefore, it is considered to be the same as that of an AP to which the terminal belongs. In other words, whether radio waves transmitted by a terminal reach other AP or other terminal is handled equally to whether radio waves transmitted by an AP to which the terminal in question belongs reach other AP in question or other terminal in question.

FIG. 4 is a diagram showing an assignment relationship between an AP and a terminal in a system where APs 401 through 404 and terminals 411 through 416 exist. In FIG. 4, as indicated by a straight line between an AP and a terminal, the terminal 411 and the terminal 412 belong to the AP 401, the terminal 413 to the AP 402, the terminal 414 and the terminal 415 to the AP 403, and the terminal 416 to the AP 404.

In the network simulation according to the present exemplary embodiment, for example, radio wave propagation situations of the terminal 411 and the terminal 412 are handled as being the same as that of the AP 401. Similarly, the radio wave propagation situation of the terminal 413 is handled as being the same as that of the AP 402, the radio wave propagation situations of the terminal 414 and the terminal 415 as that of the AP 403, and the radio wave propagation situation of the terminal 416 as that of the AP 404.

Also assuming that the radio wave propagation situations of the AP401 through A404 have such a receivability relationship as represented by the AP 301 through AP 304, the receivability relationship between the terminal 412 and the terminal 415, for example, is the same as the receivability relationship between the AP 401 and the AP 403. In this case, with reference to FIG. 3, determination is made that the AP 401 (equivalent to the AP 301 in FIG. 3) and the AP 403 (equivalent to the AP 303 in FIG. 3) are not allowed to receive from each other (i.e. an arrival situation from the terminal 412 to the terminal 415 is considered to be the same as an arrival situation from the AP 401 to the AP 403).

In the simulation, when the terminal 412 transmits a packet, determination is made whether a radio medium is busy (a state where radio waves which the terminal 412 is allowed to receive exist in the radio medium). In this case, in the common network simulation, it is necessary to individually confirm radio node transmission situations of all the ten, the AP 401 through AP404 and the terminal 411 though the terminal 416 and a situation of radio wave propagation to the terminal 412. In the network simulation according to the present exemplary embodiment, with each AP and a terminal belonging thereto considered as one cell, determination should be made based on a transmission situation of each cell and a radio wave propagation situation of an AP belonging to the cell. In other words, the network simulation according to the present exemplary embodiment only needs confirmation of as many transmission situations and radio wave propagation situations as the number of APs. As to a transmission situation of each cell, a state where any of APs and terminals included in the cell being in transmission is considered as being in transmission and a state where none is in transmission is considered as being in non-transmission.

When the network simulation ends at Step S215, the simulation result summing up unit 106 sums up a simulation result (Step S815) and the evaluation result output unit 107 outputs an evaluation result (Step S816). The processing at Step S815 and Step S816 is the same as the processing in the common network simulation shown in FIG. 8.

The simulation result summing up unit 106 sums up, on a cell basis or as a system as a whole, a packet delay and a loss rate recorded during the simulation to derive an average value and maximum and minimum values (Step S815). Then, the evaluation result output unit 107 outputs the above-described derived evaluation result in a form appropriate for a user to evaluate (external file output or displaying on a display) (Step S816). The user is allowed to determine whether a wireless LAN to be evaluated realizes desired quality or not based on the output evaluation result and feed the result back to station designing or parameter adjustment.

### Effects of First Exemplary Embodiment

As described in the foregoing, the communication quality evaluation device 100 according to the first exemplary embodiment handles a radio wave propagation situation of a terminal as being the same as a radio wave propagation situation of an AP to which the terminal belongs. In other words, no setting is required of a radio wave propagation situation between terminals. As a result, in the network simulation according to the present exemplary embodiment, the amount of information of a radio wave propagation situation to be set fails to become enormous and the number of targets to be determined is reduced at the time of determining a radio medium busy situation in the simulation, so that the amount of computation can be reduced.

### Second Exemplary Embodiment

Next, a second exemplary embodiment of the present invention will be described with reference to the drawings. Although network simulation according to the present exemplary embodiment is realized by the same procedure as that of the flow chart shown in FIG. 2, it differs from the network simulation according to the first exemplary embodiment in handling a radio node.

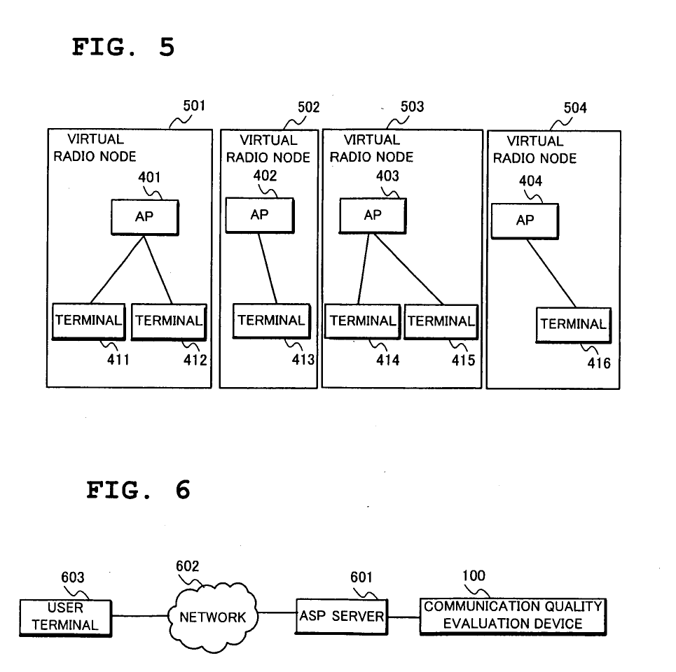

FIG. 5 is a diagram for use in explaining one example of topology handling (radio node handling) in the second exemplary embodiment. Assume that with topology to be simulated given at Step S811, as a result of setting of an AP to which a terminal belongs that is executed at Step S214, an assignment relationship between the AP and the terminal becomes the assignment relationship as shown in FIG. 4. In this case, according to the second exemplary embodiment, the network simulation (Step S215) takes a cell with a certain AP and a terminal belonging to the AP as one pair into consideration to regard the one cell as one virtual radio node (See FIG. 5).

More specifically, according to the present exemplary embodiment, a cell including three, the AP 401, and the terminal 411 and the terminal 412 belonging to the AP 401 shown in FIG. 4, is regarded as one virtual radio node 501. Also assume that the three traffics in question are transmitted from the one virtual radio node 501 and traffic directed to the AP 401, and the terminal 411 and the terminal 412 is in any case received by the virtual radio node 501. In this case, the radio wave propagation situation of the virtual radio node 501 is considered to be the same as the radio wave propagation situation of the AP 401 as the AP included in the virtual radio node in question (i.e. considered to be the same as the situation of arrival at the AP 401 to which the terminal 411 and the terminal 412 belong).

At the time of execution of the simulation, handling is easier by considering the terminal 411 and the terminal 412 as being integrated into the AP 401 but not by newly defining the virtual radio node 501 (i.e. consider that the traffic transmission and reception processing by the terminal 411 and the terminal 412 is to be executed by the AP 401). More specifically, the above-described behavior can be realized by also controlling traffic transmission and reception of the terminal 411 and the terminal 412 by the AP 401.

### Effects of Second Exemplary Embodiment

As described in the foregoing, the communication quality evaluation device 100 according to the present exemplary embodiment executes simulation related to an AP and a terminal belonging to the AP by the AP in question in the lump. This only requires simulation processing to be executed on a cell basis, while simulation processing according to the related art is executed for an individual AP and each terminal, so that the amount of processing is reduced to reduce a computation time required for simulation.

Next, description will be made of an example of making use of the communication quality evaluation device 100 according to the exemplary embodiment of the present invention. FIG. 6 is a diagram of a system structure showing one example of a structure in a case of making use of the communication quality evaluation device 100 as ASP (Application Service Provider) service. The system shown in FIG. 6 includes the communication quality evaluation device 100, an ASP server 601, a network 602 and a user terminal 603. The ASP server 601 is a server which accepts an access from the network to input/output information and which may be formed by using a Web server. The network 602 is a medium which connects the ASP server 601 and the user terminal 603 and which may be LAN, the Internet or any kind of network. The user terminal 603 is a terminal used by a user who wants quality evaluation, which is a PC or a dedicated terminal, for example.

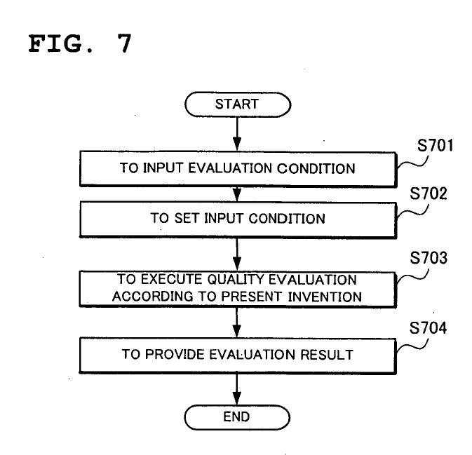

Next, operation of communication quality evaluation shown in FIG. 6 will be described. FIG. 7 is a flow chart showing a procedure of quality evaluation in FIG. 6. First, a user inputs a condition for evaluation to the user terminal 603 (Step S701). Assumed as an input method are a method of generating a file in which conditions are recited, an input method using a Web interface provided by the ASP server 601, and the like. Input conditions are provided to the ASP server 601 through the network 602.

Next, set the condition input by the user at the communication quality evaluation device 100 (Step S702). While the ASP server 601 holds the condition input by the user, the ASP server 601 modifies and sets the condition according to the set interface of the communication quality evaluation device if necessary. The setting processing is executed for each of the setting units 101 through 104 in the communication quality evaluation device 100. Upon setting the conditions, quality evaluation is executed in the system shown in FIG. 6 (Step S703).

Upon completion of the quality evaluation, the evaluation result output unit 107 in the communication quality evaluation device 100 outputs an evaluation result. Then, the ASP server 601 receives an evaluation result output by the evaluation result output unit 107. The ASP server 601 modifies the received output (evaluation result) as required to provide the obtained output to the user terminal 603 through the network (Step S704). Among method of provision to a user are downloading a filed evaluation result from the user terminal 603 and a method of, with a result put on a Web page, accessing from the user terminal 603 by the Web browser.

According to the above-described exemplary embodiment of the present invention, because a radio wave propagation situation of a terminal is considered to be the same as a radio wave propagation situation of its belonging AP, only the radio wave propagation situation of the AP is set, so that a radio wave propagation situation to be seized is only that between APs, resulting in reducing the amount of computation. As a result, time required for obtaining an evaluation result of communication quality can be reduced.

Also according to the above-described exemplary embodiment of the present invention, because a radio wave propagation situation of a terminal is considered to be the same as a radio wave propagation situation of its belonging AP, when making determination on standby or collision of a transmission packet of a certain radio node at the time of execution of simulation, it is unnecessary to confirm a transmission situation and a radio wave propagation situation of all the radio nodes and it is only necessary to confirm a transmission situation and a radio wave propagation situation on a basis of a cell with an AP and a terminal belonging to the AP as a set, thereby reducing the amount of computation. As a result, time required for obtaining an evaluation result of communication quality can be reduced.

Moreover, by handling behavior of an AP and a terminal belonging to the AP as being integrated with the AP, the above-described exemplary embodiment of the present invention enables processing during simulation which is executed equivalently to the number of all the nodes including all the APs and all the terminals to be reduced down to processing equivalent to the number of all the APs. As a result, time required for obtaining an evaluation result of communication quality can be reduced.

Although the present invention has been described with respect to the preferred exemplary embodiments in the foregoing, the present invention is not necessarily limited to the above-described exemplary embodiments and can be implemented as various modifications within a range of its technical idea.

This application claims priority based on Japanese Patent Application No. 2006-274907 filed on Oct. 6, 2006 and incorporates all the disclosure of the same.

### INDUSTRIAL APPLICABILITY

The present invention is applicable to a communication network system.

1-13. (canceled)

14. A communication quality evaluation method of a wireless LAN system using network simulation, wherein in network simulation step,
executing network simulation by considering a situation of arrival of a radio wave transmitted by a terminal at other access point to which said terminal does not belong or other terminal to be the same as a situation of arrival of a radio wave transmitted by an access point to which said terminal belongs at said other access point or other access point to which said other terminal belongs.

15. The quality evaluation method of a wireless LAN system according to claim 14, including:
a step of setting a situation of arrival of a radio wave transmitted by said access point at said other access point, and
a step of setting a relationship of assignment of a terminal to an access point.

16. The quality evaluation method of a wireless LAN system according to claim 14, wherein in said step of executing network simulation, transmission and reception processing of traffic of said terminal is considered to be executed at said access point to which said terminal belongs.

17. The quality evaluation method of a wireless LAN system according to claim 15, wherein in said step of setting a situation of arrival of a radio wave,
by using a matrix having as many rows and columns as the number of access points, the row and the column of the matrix are correlated with a reception access point and a transmission access point to set a receivability situation at said reception access point by using 1 and 0.

18. A communication quality evaluation device of a wireless LAN system which executes network simulation, comprising:
a network simulation unit which executes said network simulation,
wherein said network simulation unit, at the time of executing network simulation, considers a situation of arrival of a radio wave transmitted by a terminal at other access point to which said terminal does not belong or other terminal to be the same as a situation of arrival of a radio wave transmitted by an access point to which said terminal belongs at said other access point or other access point to which said other terminal belongs.

19. The communication quality evaluation device of a wireless LAN system according to claim 18, comprising:
a topology setting unit which sets topology of a network to be simulated,
an access point to access point radio wave propagation situation setting unit which sets a radio wave propagation situation indicating whether a radio wave transmitted by said access point reaches said other access point or not, and
a terminal belonging access point setting unit that sets to which access point a terminal included in topology set by said topology setting unit belongs,
wherein said network simulation unit executes network simulation based on a condition set by each said setting unit.

20. The communication quality evaluation device of a wireless LAN system according to claim 18, wherein said network simulation unit considers transmission and reception processing of traffic of a terminal to be executed at said access point to which said terminal belongs.

21. The communication quality evaluation device of a wireless LAN system according to claim 18, wherein said access point to access point radio wave propagation situation setting unit uses a matrix having as many rows and columns as the number of access points to correlate the row and the column of the matrix with a reception access point and a transmission access point and set a receivability situation at the reception access point in question by using 1 and 0.

22. The communication quality evaluation device of a wireless LAN system according to claim 18, comprising an evaluation result providing unit which provides other terminal with an evaluation result output by said communication quality evaluation device through a network.

23. A computer readable medium storing a communication quality evaluation program which causes a computer to execute, in simulation executing processing, processing of considering a situation of arrival of a radio wave transmitted by a terminal at other access point to which said terminal does not belong or other terminal to be the same as a situation of arrival of a radio wave transmitted by an access point to which said terminal belongs at said other access point or other access point to which said other terminal belongs.

24. The computer readable medium storing a communication quality evaluation program according to claim 23, which causes a computer to execute
a arrival situation setting processing of setting a situation of arrival of a radio wave transmitted by said access point at said other access point,
a assignment relationship setting processing of setting a relationship of assignment of a terminal to an access point, and
a simulation execution processing of executing network simulation based on the condition set by said arrival situation setting processing and said assignment relationship setting processing.

25. The computer readable medium storing a communication quality evaluation program according to claim 23, which causes a computer to execute, in said simulation executing processing, processing of considering transmission and reception processing of traffic of a terminal to be executed at said access point to which said terminal belongs.

26. The computer readable medium storing a communication quality evaluation program according to claim 23, which causes a computer to execute, in said arrival situation setting processing, processing of using a matrix having as many rows and columns as the number of access points to correlate the row and the column of the matrix with a reception access point and a transmission access point and set a receivability situation at said reception access point by using 1 and 0.

27. The quality evaluation method of a wireless LAN system according to claim 15, wherein in said step of executing network simulation, transmission and reception processing of traffic of said terminal is considered to be executed at said access point to which said terminal belongs.

28. The quality evaluation method of a wireless LAN system according to claim 14, wherein in said step of setting a situation of arrival of a radio wave,
by using a matrix having as many rows and columns as the number of access points, the row and the column of the matrix are correlated with a reception access point and a transmission access point to set a receivability situation at said reception access point by using 1 and 0.

29. The communication quality evaluation device of a wireless LAN system according to claim 19, wherein said network simulation unit considers transmission and reception processing of traffic of a terminal to be executed at said access point to which said terminal belongs.

30. The communication quality evaluation device of a wireless LAN system according to claim 19, wherein said access point to access point radio wave propagation situation setting unit uses a matrix having as many rows and columns as the number of access points to correlate the row and the column of the matrix with a reception access point and a transmission access point and set a receivability situation at the reception access point in question by using 1 and 0.

31. The communication quality evaluation device of a wireless LAN system according to claim 20, wherein said access point to access point radio wave propagation situation setting unit uses a matrix having as many rows and columns as the number of access points to correlate the row and the column of the matrix with a reception access point and a transmission access point and set a receivability situation at the reception access point in question by using 1 and 0.

32. The communication quality evaluation device of a wireless LAN system according to claim 19, comprising an evaluation result providing unit which provides other terminal with an evaluation result output by said communication quality evaluation device through a network.

33. The communication quality evaluation device of a wireless LAN system according to claim 20, comprising an evaluation result providing unit which provides other terminal with an evaluation result output by said communication quality evaluation device through a network.
